(19) United States
(12) Patent Application Publication
(10) Pub. No.: US 2024/0346157 A1
(43) Pub. Date: Oct. 17, 2024

(54) ENCRYPTION SCHEME

(71) Applicant: FRACTAL DAWN PTY LIMITED, Milton, Queensland (AU)

(72) Inventor: Wolfgang FLATOW, Conondale (AU)

(21) Appl. No.: 18/681,532

(22) PCT Filed: Jul. 13, 2022
(86) PCT No.: PCT/AU2022/050734

§ 371 Date: Feb. 6, 2024

(30) Foreign Application Priority Data
Aug. 18, 2021 (AU) 2021902586

(51) Int. Cl. G06F 21/60; G06F 21/62

(52) U.S. Cl. CPC G06F 21/602; G06F 21/6227

(57) ABSTRACT

An encryption system, the system including one or more processing devices configured to encrypt data associated with a unique identifier: determining the unique identifier associated with the data; using the unique identifier to identify a spatial region within a complex number space; determining at least one key location within the spatial region; determining a key value for each key location using a defined complex number formula; and, using each key value to encrypt the data.

### PRIORITY DOCUMENTS

The present application claims priority from Australian Provisional Application No. 2021902586 titled “FRACTAL DATABASE ENCRYPTION” as filed on 18 Aug. 2021, the content of which is hereby incorporated by reference in its entirety.

### BACKGROUND OF THE INVENTION

The present invention relates to an encryption system and method, and in one example a system and method for encrypting a database using a fractal encryption scheme, as well as a system and method for decrypting an encrypted database.

### DESCRIPTION OF THE PRIOR ART

The reference in this specification to any prior publication (or information derived from it), or to any matter which is known, is not, and should not be taken as an acknowledgment or admission or any form of suggestion that the prior publication (or information derived from it) or known matter forms part of the common general knowledge in the field of endeavour to which this specification relates.

Database encryption is used for a number of purposes, including maintaining the security of data contained within the database, as well as providing immutability, ensuring unauthorised changes cannot be made to the database.

In recent years, blockchain technologies have become popular, with these being used in a wide range of applications, including that of digital currencies, such as Bitcoin, Ethereum, or the like. Whilst not backed by physical assets, such currencies have become popular for a range of reasons, including their peer to peer utility and demand.

Blockchain technologies use a massive encrypted ledger that is maintained by thousands of servers and these ledgers contain every single transaction ever made with that currency. This ledger is then duplicated on thousands of servers and massive computing power and energy is used to maintain them. This aims to provide a high degree of security and redundancy, making it difficult for such currencies to be used fraudulently. For example, blockchain technologies have been leveraged in an attempt to track changes made to databases, thereby reducing the opportunity for unauthorised changes to be made.

However, such technologies suffer from a number of drawbacks.

One drawback, is that blockchain, and in particular crypto currencies rely on a technique called mining to generate the encrypted blocks of data. This involves performing complex calculations in order to generate the data blocks, which is in turn requires high levels of computational power, and hence energy. Thus, one of the biggest problems with Bitcoin and all other crypto currencies is mining and its associated energy usage, and whilst banks may use a lot more power maintaining their own accounts and delivering their financial services, they are handling far greater amounts of currency.

Irrespective of this, the blockchain technology relies on the ledger being distributed and stored across many databases. This in itself makes it difficult to use the system to track changes in a database. For example, this may require a database contents are hashed, with the hash then being stored in the ledger. In this case, if a new hash generated at a later time differs, this only shows the database has been altered, and not the changes made. To provide a higher degree of confidence to track changes, more information, such as hashes of different database portions, need to be stored, making this impractical on a large scale.

In any event, use of blockchain cannot prevent changes being made, and so database encryption is still required for this purpose. However, traditional current encryption techniques suffer from a number of drawbacks.

In particular, in order for encryption keys to be sufficient secure, these need to be of a sufficient size that these cannot easily be re-calculated. As encryption techniques often rely on prime numbers, there is significant computation involved in deriving encryption keys that can be used, which adds to the issues of energy usage outlined above. Furthermore, a quantum computers are refined, the issue of calculating encryption keys from encrypted data will become trivial, rendering this form of encryption effectively useless.

Additionally, no matter how strong the encryption technique is that it is used, overall the encryption process is only effective if it is possible to retain encryption keys secret. In particular, once an encryption key is known, then this can be used together with the encryption algorithm to decrypt encrypted data and reveal its contents. As keys can be hundreds of bits in length, it is not practical to remember these, and instead techniques are required to store encryption keys to allow access to encrypted data. This is frequently done by encrypting the keys using a key store, which in turn requires a key to access its contents, which is in turn often a less complex password. In the case, of username/password access control, in order to function, one or both of those values must be stored in databases as an encrypted block. While this makes the password much more secure by not being visible as plain text, this has two significant side effects, namely that the key used to encrypt the password is known to the system, by whatever algorithm or key store method, and that the password is actually stored in the system, albeit in an encrypted form.

As a result, the potential for compromise is very high should the key store system be discovered, the entire encrypted content could then be decoded, meaning the encryption key storage process is typically the weakest link in any encryption scheme, and improved systems would be desirable.

It can therefore be seen that improved techniques are required for encrypting databases and providing associated immutability.

### SUMMARY OF THE PRESENT INVENTION

In one broad form, an aspect of the present invention seeks to provide an encryption system, the system including one or more processing devices configured to encrypt data associated with a unique identifier: determining the unique identifier associated with the data; using the unique identifier to identify a spatial region within a complex number space; determining at least one key location within the spatial region; determining a key value for each key location using a defined complex number formula; and, using each key value to encrypt the data.

In one embodiment the one or more processing devices are configured to: use the complex number formula to generate a fractal value for the key location; and, derive the key value from the fractal value.

In one embodiment the one or more processing devices are configured to: generate an integer value from the fractal value; and, generating the key value from the integer value.

In one embodiment the one or more processing devices are configured to: segment the data into a plurality of data fragments; identify a respective key location for each of the data fragments; and, encrypt the data by encoding each data fragment using a key value obtained from the respective key location.

In one embodiment the one or more processing devices are configured to combine the data fragment with the key value by adding the data fragment to the key value.

In one embodiment each data fragment has a set bit length and the one or more processing devices are configured to combine the data fragment with the key value using modulo addition based on the set bit length.

In one embodiment the one or more processing devices are configured to determine a plurality of key locations within the spatial region by using the defined complex number formula at one key location to determine a next key location.

In one embodiment the one or more processing devices are configured to determine a plurality of key locations by using a value derived from a previous key location to calculate a translation to a next key location.

In one embodiment the one or more processing devices are configured to: using the complex number formula to generate a fractal value for the key location; generate two translation values from the fractal value; and, generate a translation to determine a next key location using the two translation values.

In one embodiment the two values include: a first value representing a translation length; and, a second value representing a translation angle.

In one embodiment the one or more processing devices are configured to: determine an origin key location within the spatial region using the identifier; and, determine subsequent key locations using translations from at least one of: previous key locations starting from the origin key location; and, the origin key location.

In one embodiment the one or more processing devices are configured to: use a first portion of the identifier to identify a spatial region within the complex number space; and, use second and third portions of the identifier to determine an origin key location within the spatial region.

In one embodiment the one or more processing devices are configured to use the first portion of the identifier to identify the spatial region using a look-up table.

In one embodiment the one or more processing devices are configured to: use the second and third portions to generate two translation values; and, generate a translation from a spatial region starting point to the key origin location using the two translation values.

In one embodiment the one or more processing devices are configured to: receive a user defined password; and, identify at least one key location at least in part using the user defined password.

In one embodiment the one or more processing devices are configured to at least one of: determine a sequence of geometric translations using the user password; and, determine an origin location for geometric translations using the user defined password.

In one embodiment the system is used to encrypt a database and the data is row content within the database, and the identifier is an identifier associated with the row content.

In one embodiment the data is a string of zero value bits, and the encrypted data is used as an encryption key.

In one embodiment the data is a blockchain hash.

In one embodiment the system is used to secure a blockchain and the data includes blockchain endpoints. In one broad form, an aspect of the present invention seeks to provide an encryption method, the method including, in one or more processing devices, encrypting data associated with a unique identifier by: determining the unique identifier associated with the data; using the unique identifier to identify a spatial region within a complex number space; determining at least one key location within the spatial region; determining a key value for each key location using a defined complex number formula; and, using each key value to encrypt the data.

In one broad form, an aspect of the present invention seeks to provide a decryption system, the system including one or more processing devices configured to decrypt data associated with a unique identifier: determining the unique identifier associated with the data; using the unique identifier to identify a spatial region within a complex number space; determining at least one key location within the spatial region; determining a key value for each key location using a defined complex number formula; and, using each key value to decrypt the data.

In one broad form, an aspect of the present invention seeks to provide a decryption method, the method including, in one or more processing devices, decrypting data associated with a unique identifier by: determining the unique identifier associated with the data; using the unique identifier to identify a spatial region within a complex number space; determining at least one key location within the spatial region; determining a key value for each key location using a defined complex number formula; and, using each key value to decrypt the data.

It will be appreciated that the broad forms of the invention and their respective features can be used in conjunction and/or independently, and reference to separate broad forms is not intended to be limiting. Furthermore, it will be appreciated that features of the method can be performed using the system or apparatus and that features of the system or apparatus can be implemented using the method.

### BRIEF DESCRIPTION OF THE DRAWINGS

Various examples and embodiments of the present invention will now be described with reference to the accompanying drawings, in which: —

FIG. 1A is a flow chart of an example of an encryption process;

FIG. 1B is a flow chart of an example of a decryption process;

FIG. 2 is a schematic diagram of an example of a distributed computer architecture;

FIG. 3 is a schematic diagram of an example of a processing system;

FIG. 4 is a schematic diagram of an example of a client device;

FIGS. 5A and 5B are a flow chart of a specific example of a process for encrypting a database; and,

FIG. 7 is a schematic diagram of an example of the Mandelbrot set.

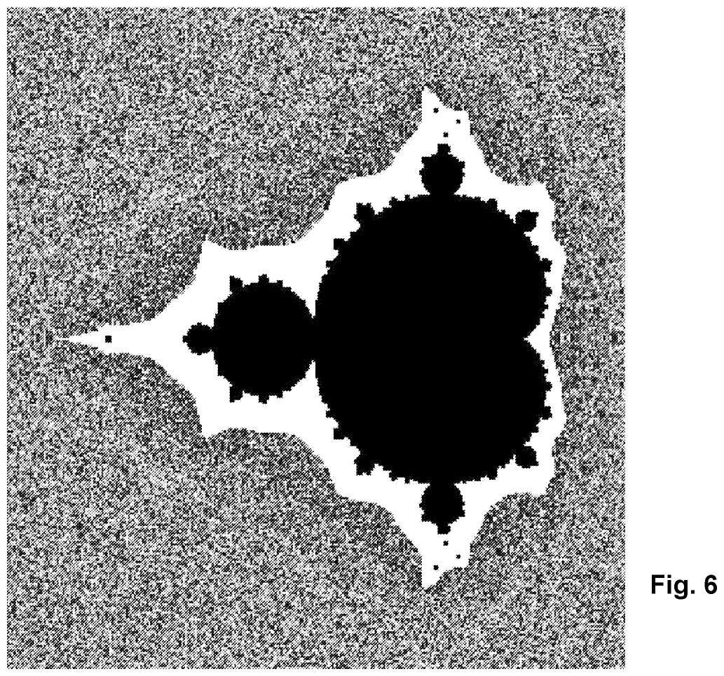

### DETAILED DESCRIPTION OF THE PREFERRED EMBODIMENTS

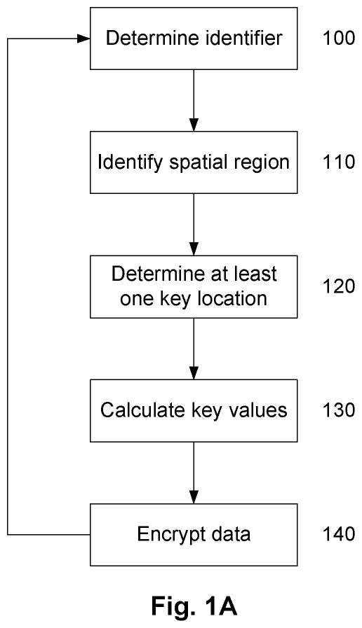

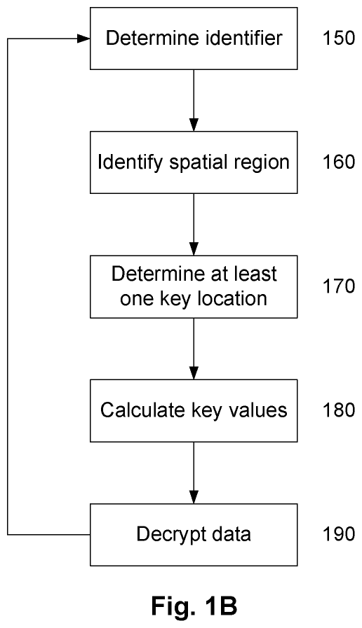

An example of processes for performing encryption will now be described with reference to FIG. 1A.

For the purpose of illustration, it is assumed that this process is performed at least in part using one or more electronic processing devices forming part of one or more processing systems, such as computer systems, servers, or the like, which may optionally be connected to one or more client devices, such as mobile phones, portable computers, tablets, or the like, via a network architecture, as will be described in more detail below. For ease of illustration the remaining description will refer to a processing device, but it will be appreciated that multiple processing devices could be used, with processing distributed between the devices as needed, and that reference to the singular encompasses the plural arrangement and vice versa.

The encryption process can be used to encrypt data associated with a unique identifier. There are numerous examples of such data, and one particular example of this is that of rows within a database. Specifically, in most relational databases data is stored in rows, with each row in the database having a unique identifier. Accordingly, the herein described encryption process can be usefully applied to encrypting row content within a database using the row identifiers so that each row is encrypted differently. Nevertheless, it will be appreciated that the approach can be applied more broadly to encrypt any data associated with an identifier. Whilst the following description will focus on the example of encrypting a database for ease of illustration, it will be appreciated that this is not intended to be limiting.

As mentioned above, in the database context, each row of the database is encrypted separately, with the encryption being performed based on a unique identifier (ID) associated with the row. Unique IDs are used universally in data systems to facilitate relationships between different data tables and databases. In one example, the unique identifier is a Globally Unique Identifier (GUID), which is a 512 bit number represented by 32 hexadecimal characters created using well established GUID generation algorithms. However, this is not essential, and other unique identifiers could be used.

Thus, in this example, at step 100, the processing device determines the identifier associated with the data to be encrypted. In the database example, this therefore involves determining the row identifier associated with row content, which is typically achieved by accessing and retrieving this using a database query.

At step 110 a spatial region in a complex number space is determined using the identifier. The complex number space can be of any appropriate form, but is typically populated with values derived utilising a complex number formula, and in one particular example chaotic complex number formula, such as those used to generate fractal sets, including Julia or Mandelbrot sets. This results in a complex number space populated with numerical values, with the values being derived based on iterations of the formula. Such complex fractal sets are well known in the art and thus will not be described in further detail. It will be noted that in order for the techniques to operate the complex space does not actually need to be populated and numerical values can be calculated on demand, as will be described in more detail below.

The spatial region could be of any appropriate form and could include an area within the complex space. In this regard, complex space typically include two dimensions in the form of axes, corresponding to real and imaginary parts of the complex numbers. However, it will also be appreciated that a third dimension in the form of depth can be provided corresponding to a depth of iteration of the complex number formula, which will result in further numerical values. Accordingly, whilst the spatial region could be an area, the region could also be a volume including an area and depth.

The spatial region could be identified in any appropriate manner. For example, the spatial region could have been previously defined, in which case the identifier may be used to access a look-up table to locate the spatial region. In this instance, some or all of the identifier could be used to retrieve the identity of the spatial region, and this could involve a many-to-one mapping, so that multiple identifiers all point to the same region, or a one-to-one mapping, so that each identifier points to a unique spatial region. Alternatively, if the spatial region has not been previously characterised, this could involve a discovery process to identify a region of the complex space that is not currently utilised and is of sufficient complexity. As a further alternative, the identifier could be used to derive a vector value used to locate the spatial region.

At step 120, at least one, and more typically multiple key locations are identified in the spatial region. The term “key location” refers to a location within or mapped to the spatial region that is used to generate a “key value”, which is a numerical value used to encode the database content. The key locations can be determined in any appropriate manner, but this is typically performed at least in part utilising the identifier, and optionally a user defined password. In one particular example, this is achieved utilising a series of translations within or mapped to the spatial region, which are derived from the identifier, and may optionally take into account the user defined password.

For example, the identifier can be used to determine an initial origin key location within the spatial region, with this being used to derive a first key value. The first key value can then be used to calculate a translation to a next key location, with this in turn being used to generate a further key value, with this process being repeated as needed. Identification of the origin key location and/or the translations could be performed taking the password into account, so that the origin location and/or sequence of translations differ based on the password used. Consequently this process results in different key values that are unique for any given identifier and any optional password.

At step 130, a key value is calculated for each key location using the complex number formula. Thus, the complex number formula is executed in order to derive a numerical value at each of the key locations identified at step 120. In this regard, it will be appreciated that the execution of the formula could occur once the key locations have been identified, meaning it is not necessary to pre-calculate numerical values for the complex space.

However, this is not essential and alternatively, pre-calculated numerical values could simply be retrieved as needed.

At step 140, the key values are utilised as an encryption key in order to encrypt the data, such as the database content within the respective row. This can be achieved in any manner, but typically involves adding the key values to the data, so that the data and key values are combined to generate a new value, which can only be used to recover the original data in the event the key values are known.

Accordingly, the above described process allows for data, such as content within a row in a database, to be encrypted using a unique identifier associated with the data, and optionally taking into account a user generated password, as will be described in more detail below. In the case of database encryption, as the encryption values functioning as the encryption key are unique for each identifier, this in turn means that each row in the database is effectively encrypted using a different and unique key, which in turn make it difficult for a third party to circumvent the encryption. For example, it prevents a third party using a brute force or other similar approach to derive a single key being used to decrypt the entire database.

The encryption key is derived from the unique identifier using the relationship between the unique identifier and the spatial region, and this relationship can be arbitrary allowing it to be easily obfuscated. For example, the relationship could be stored in a look-up table, so that without access to the look-up table, it isn't possible to identify the spatial region from the identifier, making it difficult for a third party to derive this from the identifiers or encrypted data. This process can be further obfuscated by allowing different parts of the identifier to be used to locate origin locations with the region, which are used in calculating the key, so a third party would need to understand this segmentation of the identifier, and have access to the look-up table, in order to recreate the key.

Furthermore, the use of a user defined password can an additional layer of complexity, making it extremely difficult to circumvent the encryption process.

Despite this, decryption can be performed in a largely equivalent manner as shown in FIG. 1B. In this instance, steps 150 to 180 are identical to steps 100 to 130 as described above, with the resulting encryption key derived from the one or more key values, being used to decrypt the encrypted data at step 190, for example by subtracting the key values from the encrypted data.

Accordingly, it will be appreciated that the above described approach leverages the complexity of the complex space to allow data such as database rows to be encrypted based on a unique identifier, such as a row identifier associated with the database row. This in turn makes the process of breaking the encryption through brute force approaches virtually impossible by virtue of the need to calculate a unique key for each database row. Despite this, the process allows for data to be easily decrypted by those having access to the relationship between the row identifier and the complex space, thereby balancing security and ease of use.

Furthermore, the key locations can also be derived from a unique user defined password, meaning that as long as the password is kept secret, it is not possible for third parties to derive these numerical values and reconstruct the key values needed to decrypt encrypted data.

Nonetheless, by virtue of the fact that key values can be generated based on a unique spatial region, this in effect precludes duplication of encryption keys, relying on differences in both user defined password and unique identifiers to generate a unique sequence of key values, which is further enhanced in the event that GUIDs are used.

Despite this, the encryption key is deterministic in the sense that the key values can be computed based on knowledge of the identifier, and hence spatial region location within the complex number space and optionally the user defined password. As a result, as long as the unique identifier and optionally the user defined password are known, the key values can be calculated, whilst key security is maintained as long as the password and/or mapping of the identifier to the spatial region are kept secret. As the spatial region location can be easily derived from the unique identifier, defined based for example on a three-dimensional coordinate vector, this provides a mechanism that allows key values to be easily calculated from easily remembered information, whilst making the encryption keys virtually impossible to reverse engineer or otherwise derive.

This therefore obviates the problems associated with traditional encryption keys, namely the computational expensive process of generating unique keys, and also the difficulty in being able to securely store keys. In particular, the ability to regenerate the key using easily remembered information absolutely avoids the need for the encryption key to ever be stored, thereby largely mitigating the issues associated with key storage.

It will therefore be appreciated that encryption processes performed utilising such approaches can result in vastly superior encryption, avoiding key storage, the weakest link of existing encryption processes, as well as reducing the technical problems associated with encryption key derivation and storage.

As previously mentioned, although the above described example has focused on encryption of a database, it will be appreciated that the approach could be used to encrypt any data associated with a unique identifier, and that reference to database encryption is not intended to be limiting, although the approach is particularly suited for use with a database for the reasons described.

A number of further features of such arrangements will now be described.

The key value at a key location can be calculated in any appropriate manner. In one example, this is achieved by calculating a fractal value using an iteration of the complex number formula, and then deriving the key value from the fractal value. For example, this can involve generating an integer value from the fractal number with this being truncated or otherwise shortened to a desired length, based on a desired size of the key value, to generate the key value. In one particular example, eight bit key values are calculated for each location, with this being achieved by calculating a 30 digit fractal number using iterations of the complex number formula, and then truncating an integer portion of the number to result in an eight bit number. The number of iterations used may be a set value, could be defined based on the spatial region being used, could be defined as, or derived from the unique identifier, or the like, and the approach used doesn't matter as long as this is able to be used during encryption and decryption, so the calculations performed are identical during each process.

Once calculated, the key values can be used to encrypt the data. In one example, this is achieved by segmenting the data into a plurality of data fragments, identifying a respective key location for each of the data fragments and then encrypting the data by encoding each data fragment using a key value obtained from the respective key location. Thus, in one example, each data fragment typically has a set bit length, such as n bits, and the key values are calculated with the same size, so that the number of n bit key values calculated is equal to the number of n bit data fragments making up the data.

The encoding can then easily be performed by adding the data to the corresponding key value, with this typically being performed using modulo addition based on the set bit length, so that in the above example, the resulting value has an n bit length. Using modulo addition prevents the maximum value for an n bit string being exceeded ensuring the encrypted data has the same n bit size. However, it will be appreciated that other suitable approaches for encoding the data fragments could be used.

In one example, the processing device determines a plurality of key locations within the spatial region by using the defined complex number formula at one key location to determine a next key location. In one particular example, this involves determining a sequence of key locations by using the key value for a previous key location to calculate a translation, such as a direction and distance, to a next key location. Thus, the key value calculated at one location is used to determine the translation to the next location, as well as being used to encode the row content. This is particularly advantageous as this approach means that only a single initial origin location in the complex space is needed in order to derive multiple key values from different locations within the complex space.

The manner in which the translation is determined will vary depending on the preferred implementation, but in one example, this involves using the complex number formula to generate a fractal value for the key location, generating two translation values from the fractal value and then using the two translation values to generate the translation determine the next key location. The translation values could just be respective parts of the fractal number, although in another example, the fractal value could be combined with other numbers, such as multiplying by one or more prime numbers, in order to generate the translation values. A further alternative would be to determine the translation values directly from the key value, for example using the key value to generate the translation values.

The nature of the translation can be of any appropriate form, but in one example are angles from a defined axial direction, such as an x (real) or y (imaginary) axis, and a distance from a starting point, such as a location derived from the unique identifier. For example, the two values could include a first value representing a translation length and a second value representing a translation angle and/or could translation along orthogonal axes.

The translations could also be generated and/or modified using any optional password. Whilst this could be achieved in any suitable manner, in one example, when a password is used ASCII values of alphanumeric characters in the password can be used to create values, which in turn are used to calculate the translation. For example, the password can be segmented into two portions, with each portion being used to calculate a value, which is then used to calculate the translation, such as by adding these to the translation values calculated from the fractal or key value.

The translations are typically calculated based on the origin key location, which can be derived from the unique identifier using any suitable technique. For example, this can be achieved by using a first portion of the identifier to identify a spatial region within the complex number space and then using second and third portions of the identifier to determine an origin key location within the spatial region. Thus, a look-up table or other mapping is used to relate part of the identifier to a particular region of the complex space, with this mapping typically being predetermined during a discovery process. Following this, second and third portions of the identifier are used to locate an origin key location within the spatial region of the complex space. Thus, this approach maps each unique identifier to a different key location within the complex space, even if multiple identifiers are mapped to the same spatial region, thereby ensuring unique key values are generated for each unique identifier.

The origin location can also be calculated using a password. For example, a password could be used to derive a translation from a location determined using the unique identifier, so that the origin key location is offset from a location that would be determined from the unique identifier alone. This in turn will lead to the calculation of different key locations and hence different key values, meaning that the identifier can be used in conjunction with a user defined password to result in different encryption of the row content.

Once the origin location has been determined within the spatial region using the identifier and optionally the password, the translations to identify further key locations can be performed. Subsequent key locations can be determined using translations from the origin key location, so that each translation is from the origin location, or translations could be from a previous key location, so that the sequence of translations progressively extend along a path from the origin location, depending on the preferred approach.

However, the key locations and key values are determined, it will be appreciated that the above described processes are not reversible, and hence are one way, meaning that if a password is used, it is not possible to derive a password from an encryption key. This further helps ensure security of the system, meaning that even if a third party is able to intercept an encryption key associated with an asset, they would not be able to recover the password and hence unlock the asset and/or any other asset. Nevertheless, as the key locations and hence key values are calculated deterministically from the identifier and optionally the password, this allows the key values to be recovered assuming the identifier and optionally the password are known, in turn allowing the database to be decrypted in a similar manner.

Thus, it will be appreciated that data, such as row content, can be decrypted by determining an identifier associated with the data, using the identifier to identify a spatial region within a complex number space, determining a plurality of key locations within the spatial region, determine a key value for each key location using a defined complex number formula and using the key values to decrypt the data.

In one example, the data includes a string of zero value bits, and the encrypted data is used as an encryption key. In this regard, the resulting encryption key is referred to as an invisible key as it does not need to be stored in the system, and can be generated based on a string of zero bytes, being recreated as needed based on an identifier, which could be a password or other similar identifier.

In another example, the data is a blockchain hash. In one specific example, this approach can be used to secure a blockchain by using the approach to encrypt blockchain endpoints. For example, a blockchain hash of the start of the blockchain can be encrypted using an invisible key, whilst the endpoint of the blockchain can be encrypted each time the blockchain is extended. Re-encrypting the blockchain end points at a later time can be used to identify if the blockchain has changed, in turn imparting a mechanism to ensure immutability that avoids distributing a blockchain ledger.

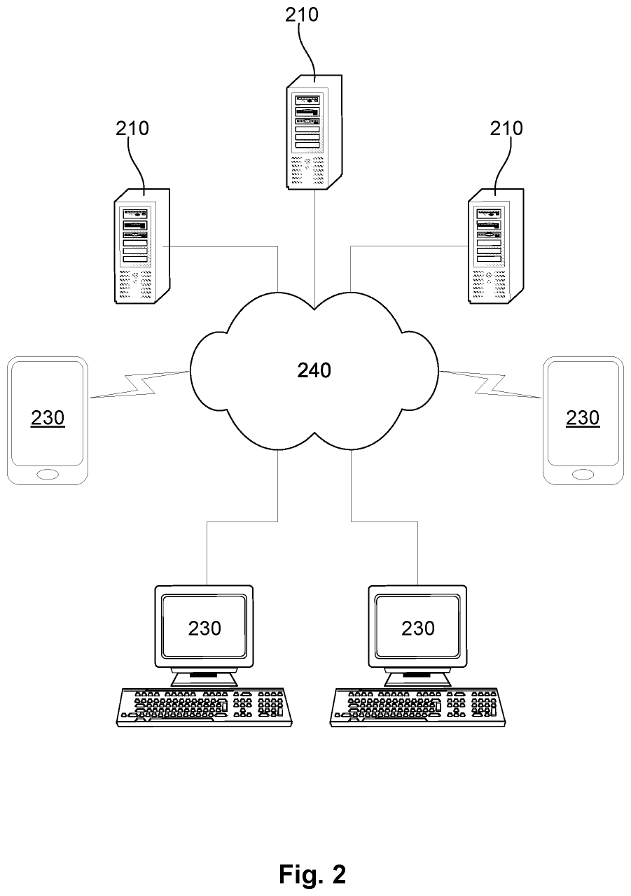

As mentioned above, in one example, the process is performed by one or more processing systems and client devices operating as part of a distributed architecture, an example of which will now be described with reference to FIG. 2.

In this example, a number of processing systems 210 are coupled via communications networks 240, such as the Internet, and/or one or more local area networks (LANs), to a number of client devices 230. It will be appreciated that the configuration of the networks 240 are for the purpose of example only, and in practice the processing systems 210 and client devices 230 can communicate via any appropriate mechanism, such as via wired or wireless connections, including, but not limited to mobile networks, private networks, such as an 802.11 networks, the Internet, LANs, WANs, or the like, as well as via direct or point-to-point connections, such as Bluetooth, or the like.

In one example, each processing system 210 is able to perform a search of complex space and identify spatial regions, calculate key locations and values, and use these to encrypt data within a database. Client devices 230 are able to interact with the processing systems 210 to allow for user interaction with the data, or the like. Whilst the processing system 210 is shown as a single entity, it will be appreciated that in practice the processing system 210 can be distributed over a number of geographically separate locations, for example by using processing systems 210 and/or databases that are provided as part of a cloud-based environment. However, the above described arrangement is not essential and other suitable configurations could be used.

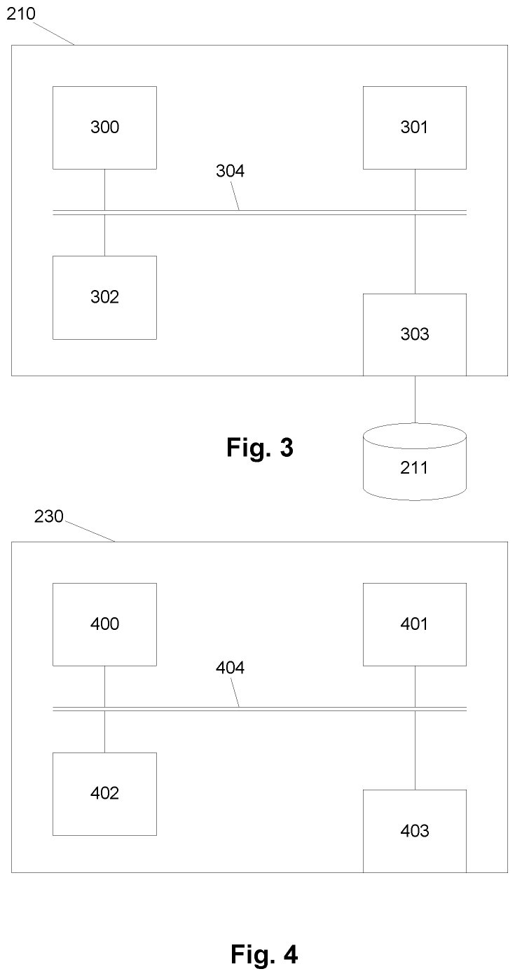

An example of a suitable processing system 210 is shown in FIG. 3.

In this example, the processing system 210 includes at least one microprocessor 300, a memory 301, an optional input/output device 302, such as a keyboard and/or display, and an external interface 303, interconnected via a bus 304 as shown. In this example the external interface 303 can be utilised for connecting the processing system 210 to peripheral devices, such as the communications network 240, databases, other storage devices, or the like. Although a single external interface 303 is shown, this is for the purpose of example only, and in practice multiple interfaces using various methods (eg. Ethernet, serial, USB, wireless or the like) may be provided.

In use, the microprocessor 300 executes instructions in the form of applications software stored in the memory 301 to allow the required processes to be performed. The applications software may include one or more software modules, and may be executed in a suitable execution environment, such as an operating system environment, or the like.

Accordingly, it will be appreciated that the processing system 210 may be formed from any suitable processing system, such as a suitably programmed client device, PC, web server, network server, or the like. In one particular example, the processing system 210 is a standard processing system such as an Intel Architecture based processing system, which executes software applications stored on non-volatile (e.g., hard disk) storage, although this is not essential. However, it will also be understood that the processing system could be any electronic processing device such as a microprocessor, microchip processor, logic gate configuration, firmware optionally associated with implementing logic such as an FPGA (Field Programmable Gate Array), or any other electronic device, system or arrangement.

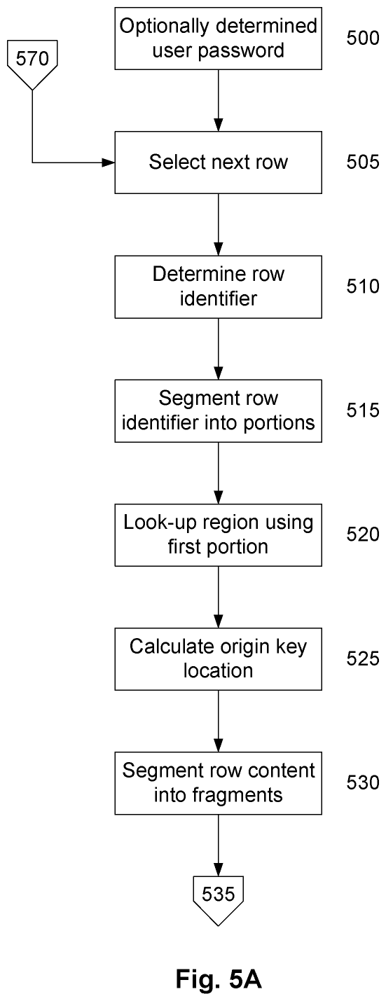

An example of a suitable client device 230 is shown in FIG. 4.

In one example, the client device 230 includes at least one microprocessor 400, a memory 401, an input/output device 402, such as a keyboard and/or display, and an external interface 403, interconnected via a bus 404 as shown. In this example the external interface 403 can be utilised for connecting the client device 230 to peripheral devices, such as the communications networks 240, databases, other storage devices, or the like. Although a single external interface 403 is shown, this is for the purpose of example only, and in practice multiple interfaces using various methods (eg. Ethernet, serial, USB, wireless or the like) may be provided.

In use, the microprocessor 400 executes instructions in the form of applications software stored in the memory 401 to allow communication with the processing system 210, for example to allow asset data to be received.

Accordingly, it will be appreciated that the client devices 230 may be formed from any suitable processing system, such as a suitably programmed PC, Internet terminal, lap-top, or hand-held PC, and in one preferred example is either a tablet, or smart phone, or the like. Thus, in one example, the client device 230 is a standard processing system such as an Intel Architecture based processing system, which executes software applications stored on non-volatile (e.g., hard disk) storage, although this is not essential. However, it will also be understood that the client devices 230 can be any electronic processing device such as a microprocessor, microchip processor, logic gate configuration, firmware optionally associated with implementing logic such as an FPGA (Field Programmable Gate Array), or any other electronic device, system or arrangement.

Examples of the processes for encrypting data in a database will now be described in further detail. For the purpose of these examples it is assumed that one or more processing systems 210 interact with the database based on user inputs provided via the client devices 230. In one example, to provide this in a platform agnostic manner, allowing this to be easily accessed using client devices 230 using different operating systems, and having different processing capabilities, input data and commands are received from the client devices 230 using via a webpage, with resulting visualisations being rendered locally by a browser application, or other similar application executed by the client device 230. The processing system 210 is therefore typically a server (and will hereinafter be referred to as a server) which communicates with the client device 230 via a communications network 240, or the like, depending on the particular network infrastructure available.

To achieve this the server 210 typically executes applications software for hosting webpages, as well as performing other required tasks including storing, searching and processing of data, with actions performed by the processing system 210 being performed by the processor 300 in accordance with instructions stored as applications software in the memory 301 and/or input commands received from a user via the I/O device 302, or commands received from the client device 230. It will also be assumed that the user interacts with the server 210 via a GUI (Graphical User Interface), or the like presented on the client device 230, and in one particular example via a browser application that displays webpages hosted by the server 210, or an App that displays data supplied by the server 210. Actions performed by the client device 230 are performed by the processor 400 in accordance with instructions stored as applications software in the memory 401 and/or input commands received from a user via the I/O device 402.

However, it will be appreciated that the above described configuration assumed for the purpose of the following examples is not essential, and numerous other configurations may be used. It will also be appreciated that the partitioning of functionality between the client devices 230, and the server 210 may vary, depending on the particular preferred implementation. Thus, whilst the following process is described as being performed distributed between the server 210 and client devices 230, it will be appreciated that this could be performed solely on a client device 230 and/or solely on a server 210.

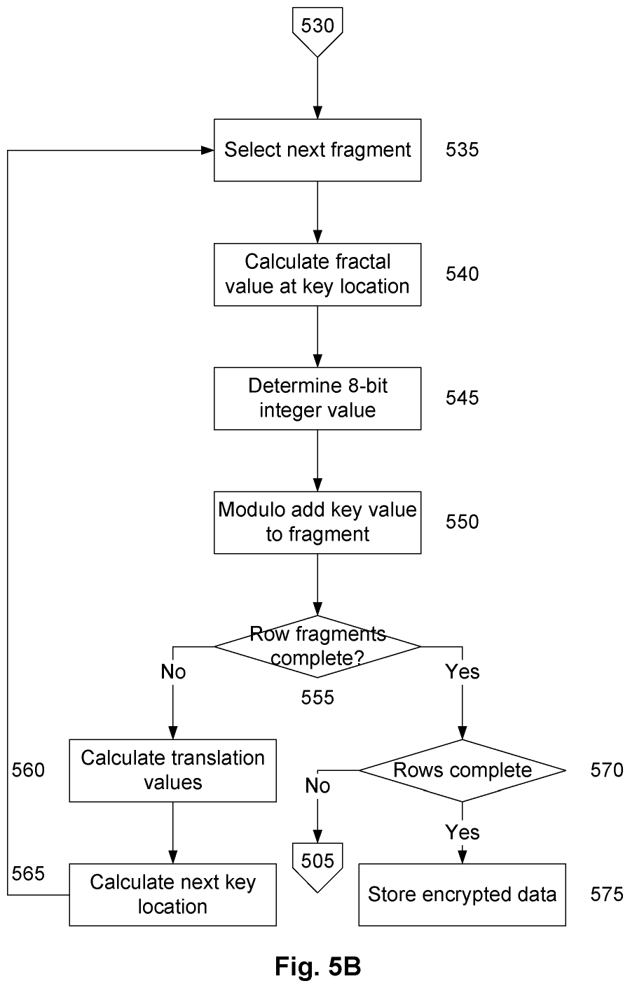

An example of a process for encrypting data in a database to thereby perform database encryption will now be described with reference to FIGS. 5A and 5B.

In this example, the server 210 optionally determines a password at step 500, with this typically being supplied by a user via the client device 230.

At step 505, the server 210 selects a next row in the database, and determines a row identifier associated with the row at step 510. It will be appreciated that this information can be retrieved by querying the database in an appropriate manner.

At step 515, the server 210 segments the unique identifier into three portions. The particular segmentation used will depend on the nature of the identifier and the preferred implementation, so for example when using a GUID, the GUID could be split into a first portion of 16 bits and second and third portions of 56 bits each.

At step 520 the first region is used to look-up a spatial region in the complex space. In this regard, spatial regions are typically mapped to different first portion values during a discovery process that analyses the complex space to identify spatial regions that have not previously been allocated to other identifier portions. Typically, this process will also examine a complexity of any identified spatial regions and validate that these are sufficiently complex in order to allow unique identifiers and encryption keys to be created, and also to ensure these do not contain infinite values. As the complex space is essentially infinite in size, it will be appreciated that this allows a large number of different spatial regions to be created which meet this criteria.

Following this, at step 525 the server 210 calculates an origin location. In one example, this is performed solely on the basis of the identifier, using the second and third portions of the identifier to calculate first and second translation values, which are in turn used to define a translation length and angle from a defined starting location in the complex region, which could correspond to a centre or corner of the region, or the like. Optionally, this step can also involve using the user defined password, so that the translation values are modified using the password, for example using ASCII values of characters within the password to calculate modified first and second translation values. In either case, the translation values are used by the server 210 to identify an origin key location within the spatial region at step 525.

At step 530, the server 210 splits the row content into fragments having a defined bit length, for example, splitting the row content into multiple 8 bit fragments, allowing each of these fragments to be encoded separately.

At step 535, the server 210 selects a next fragment and then calculates a key value at a current key location (which is the key origin location for the first fragment). The key value is calculated by using a set number of iterations of the complex number formula defining the complex space, performed to a set depth, to generate a fractal number having a defined number of digits at step 540. An 8-bit integer value is then determined from the fractal number at step 545, such as by truncating the fractal number, with this being used as the key value. This allows the key value to be combined with the row fragment at step 550, using modulo 256 addition, which results in an 8-bit value forming the encoded row fragment.

It is determined if the row fragments are complete at step 555, and if not then at step 560, the server 210 calculates two translation values from the fractal value calculated at step 540. The translation values are typically generated by performing modulo addition with defined prime numbers, although this is not essential and other approaches could be used. At step 565, the translation values are used as an angle and distance to calculate a next key location.

Steps 535 to 555 are then repeated, with this being performed for each of the row fragments, until each row fragment is encoded.

Once this has been done, at step 570, the server 210 determines if the rows have been completed, if not returning to step 505 allowing the next row to be encoded, with encrypted data being stored at step 575, for example once all rows have been encoded. In this instance, the encrypted data will include an unencrypted row identifier associated with encoded row content.

It will be appreciated that this provide a mechanism for encrypting the row content based on the row identifier and optional password. In the event that decryption is to be performed, the same process is repeated, with the row fragments being formed from fragments of encoded row content, and with modulo subtraction being performed instead of addition at step 550, to thereby recover the original row fragment values.

Accordingly, the above described approach covers a method to encrypt and secure data associated with identifiers, such as data resident in a database, using the fractal domain. In one example, the database implements a unique ID for each table row, such as a GUID, and the fractal is the Mandelbrot Set.

The approach provides a system of encryption for data contained in the database tables and can be implemented to secure specific column data and/or form part of blockchain validation for the entire contents of the table.

In this regard, database encryption is desired so that critical security data can be stored in an encrypted manner. A significant challenge with using conventional encryption, where an encryption algorithm function takes a key and payload as input and outputs a crypt-block, is key management. In the age of Quantum Computing there is also the additional challenge of guarding against Quantum decryption, which can break the encryption decryption asymmetry.

The fact that database records usually have IDs has not previously been considered to yield security benefits for row and blockchain encryption or key management, as conventional hash or derivative functions are easily duplicated and certainly unsuitable as a key. The above approach brings a new fractal paradigm that maps every possible ID to a unique location in fractal space, which opens a broad vista of potentials and possibilities for fractal encryption and key management.

The approach provides a method of ID to fractal mapping and the processes of fractal encryption/decryption that can be implemented with a unique fractal x,y starting point. This enables a fully functional fractal security service using the Mandelbrot Set and GUIDs, implementing keys and multi pass encryption. The resulting services have been successfully tested with trillions of GUID, key, number of passes and payload combinations.

The steps to implement the approach can include:
1) Configure fractal x1,y1-x2,y2 regions that do not contain infinity.
2) Create a numerical mapping table to the fractal regions of step [1].
3) Split the table row ID into 3 sections:
   a) Fractal region pointer
   b) X coordinate
   c) Y coordinate
4) For a given ID in step [3] calculate its unique key location x,y by adding X coordinate [b] to the respective x1 region of step [1] and adding the Y Coordinate [c] to the respective y1 region of step [1].
5) Obtain a fractal key value at the key location x,y of step [4].
6) Step over the payload data in n bit fragments.
7) For each fragment of step [6] perform a plane geometry function seeded by the previous x,y fractal key value of step [5] to obtain a new x,y location.
8) At each step [7] obtain a fractal value at the new x,y location.
9) Convert the fractal value obtained at step [8] to a binary n bit value range matching the n bit fragments obtained in step [6].
10) Add the converted value obtained in step [9] to the payload n bit fragment obtained in step [6].
11) If the sum obtained [9] is greater than the maximum binary value of 2\hat{ }n bit fragment then subtract the maximum value of 2\hat{ }n bit fragment from the sum.
12) Store the converted value of step [11] in a buffer with a binary length equivalent to the payload in the same position as the current step [6].
13) The buffer now contains the encrypted data.

The preferred ID is a GUID, which is a 128 bit binary number. In one example, the following method is used to divide the GUID into 3 parts:
1) Bits 0 to 15 (16 bits) map to one of 65,536 surveyed fractal regions
2) Bits 16 to 71 (56 Bits) map to the X coordinate
3) Bits 72 to 127 (56 Bits) map to the Y coordinate

To decrypt the data the process is repeated using the buffer contents as payload and performing a subtraction step at step [10] and adding the maximum binary value of 2\hat{ }n bit fragment [6] if the value goes below zero (0) at step [11].

To configure regions that do not contain infinity, x,y locations that do not return from the fractal iteration formula, a complexity testing algorithm may be used to survey the fractal region.

The plane geometry function can be x,y addition, subtraction, multiplication, division, rotation etc.

The fractal values extracted at each unique x,y location are large numbers with very high precision and a variety of methods can be choosen to obtain values in the range of 2\hat{ }n bits, values to use for the next geometric function to compute the next x,y location and values to determine different geometric functions if there are more than one.

A specific fractal mapping example will now be described.

An example fractal in the form of a Mandlebrot complexity scan is shown in FIG. 6. In this example, the black central region is excluded as this extends to infinity, whilst the surrounding white region is also excluded as some of this also include infinity.

There are 65536 (2\hat{ }16) colored fractal regions without infinity, each 0.01×0.01 square. These are used in the example below.

Each square 0.01×0.01 fractal region is scaled to 72057594037927900×72057594037927900 (2\hat{ }56×2\hat{ }56). 16+56+56=128 (The size of a GUID in bits).

The size of one fractal region unit is =0.0000000000000000001387778781 (0.01/2\hat{ }56).

GUIDS are hexadecimal values with a binary number space 2\hat{ }128.

For a sample GUID:96FD114B-FC16-4586-9851-AEF9B1FC7E75, this can be split into three regions as shown in Table 1.

TABLE 1

| | Hexadecimal | Decimal | x, y |
|---|---|---|---|
| Region | 96FD | 57193 | 0.505, −0.565 |
| Region X | 114BFC16458698 | 38676783436903473 | 0.0053674819371066892174606413 |
| Region Y | 51AEF9B1FC7E75 | 24743199681538601 | 0.0034338087492085227900225381 |

Fractal Region 57193 top left is x,y: 0.505, −0.565. Region X and Region Y decimal values are multiplied by the region unit of 0.0000000000000000001387778781 to yield their position within the Fractal Region. The Region X and Region Y are added to the Fractal Region top left x,y to arrive at the Sample GUIDs fractal location at x,y: 0.5103674819371066892174606413, −0.5615661912507914772099774619.

An example encryption process will now be described. In this example, the sample text “This is something to encrypt” is encrypted using the Sample GUID above.

### Initialization:

1) Calculate the fractal value at the GUID x,y fractal location (above)=535174.066493319
2) Remove the decimal point=535174066493319
3) Obtain angle (0) 535174066493319 mod 347=152
4) Obtain hypotenuse (0) 535174066493319 mod 7919=5338

Build Fractal Value Array (Some process values are shown, but they are a subset and not intended to be limiting):

Loop(n) the following for the byte length of the text (or file) . . .
1) Calculate a new x,y(n) position from GUID Fractal Location angle(n) and hypotenuse(n) using Pythagorean geometry.
2) (n=1: 0.5103674819370984295341462991, −0.5615661912507870854584566892)
3) Calculate the fractal value at the x,y(n) location (n=1: 535174.066492741)
4) Remove the decimal point (n=1: 535174066492741)
5) Store fractal value mod 256 in array(n)
6) Obtain new angle(n) 535174066492741 mod 347
7) Obtain new hypotenuse(n) 535174066492741 mod 7919
8) Repeat from 1. for length of payload bytes

### Apply Fractal Value to Payload:

Loop over the array and add its value to the corresponding byte value of the payload.

If the value is greater than 256 then subtract 256.

The resulting encrypted string is (approximately as some values do not render easily):
+÷À″ [symbol] La-©Ûëszm.åÏ«¿ [symbol] W

Decryption subtracts the array values from the encrypted string, adding 256 if it falls below zero.

### Extensions

A number of other variations and extensions will now be described.

The encryption approach has many possible extensions in its use, and can be applied in a wide range of situations. For example, the approach can be extended to any data associated with a unique identifier and is not limited to applications associated with databases.

The encryption approach does not require a key, unique encryption is provided based on a unique ID. While the ID can be utilized as a key, it is not indented as such. Rather the ID selects a unique fractal region to perform the fractal encryption. Nevertheless, an independent key can be introduced by pre-running the process above using a key as payload (without loading a buffer) to obtain a new unpredictable x,y location and using that as the starting point for the encryption.

Multiple passes can re-order the binary data based on the fractal values obtained in the above process.

The encryption process can be repeated n times by transferring the buffer to the payload at the end of each pass while maintaining the last x,y key location between passes.

The above process can be run with a seed of zero bits to obtain unique unpredictable keys not otherwise visible in the system (referred to generally as invisible keys). In this example, a data string of including multiple zero bits is encrypted based on an identifier and/or password, with the resulting encrypted data acting as an encryption key for downstream encryption. In this instance, the key itself need not be stored, but rather the identifier or password used to generate the key is stored.

For each step [6] a selection of vector transforms and plane geometry functions can be implemented based on fractal values obtained.

The encryption approach is suitable for a broad range of security applications and example major applications include but are not limited to database encryption, and blockchain security.

### Database Encryption

The database encryption approach utilises an ID to map to unique fractal locations. In this regard it is normal practice to define a unique ID column for each database table and/or object, and this can be used to encrypt each row in the database.

In a preferred embodiment the ID is a GUID, that is a 128 bit binary number, divided into 3 parts:
1) Bits 0 to 15 (16 bits) map to one of 65,536 surveyed fractal regions
2) Bits 16 to 71 (56 Bits) map to the X coordinate
3) Bits 72 to 127 (56 Bits) map to the Y coordinate

A complexity test surveys and maps 65,536 fractal regions without infinity. The fractal x and y coordinates are scaled to fit 72057594037927900×72057594037927900 (2\hat{ }56) locations for each surveyed fractal region. The combined scaled locations for all surveyed fractal regions=2\hat{ }128 and therefore yields a unique fractal location for all possible GUIDs.

### Blockchain Security

Blockchain technology has gained a reputation for delivering verifiable data immutability integrity to database tables, specific table columns and records.

Blockchain hashes table column data concatenated with the hash of the previous (ordered) record to write the resulting hash to the current record, creating a one-way sequence encrypted record chain.

A fast validation can be performed by repeating the above process for a given record and comparing the existing hash with the computed hash. A complete validation can be performed by repeating the above validation for all records in the table.

If validation fails then you have detected data corruption or un-authorised tampering with the data and/or hashes. Blockchain is really simple in essence but it has a re-processing vulnerability, where an attacker makes a change to a block or record and re-processes the chain from there. There are two methods used to overcome this vulnerability:
1) Decentralisation—using a crypto currency to reward external and decentralised miners to apply a majority vote on the blockchain state to verify it has not been altered whenever a blockchain item is added.
2) Blockchain endpoint security—a method of storing an encrypted copy of the last blockchain hash that is used to validate the blockchain, that is updated when new records are added.

Option 1. has the further vulnerability of validating with a 51% vote. It also requires the operation and valuation of a cryptocurrency and corresponding mining software. It has an advantage of perceived decentralised trust.

Option 2. has a further vulnerability of encryption key management. It has the advantage of standalone blockchain security and a disadvantage in that there is no perceived decentralised trust.

As the aim of blockchain implementation is to guarantee that the protected data has not been deleted, edited or inserted, that guarantee rests on provable validation and verification systems that cannot be attacked or hacked. Blockchain, by itself, does not meet that criteria as it has a well-known re-processing vulnerability. Blockchain must implement a solution to address this vulnerability.

Yet the decentralised method is very elaborate and cumbersome and the endpoint encryption method has a clear key management vulnerability, that is, the key that must be known to operate the solution is the weak point.

However, in contrast, the above encryption process can be utilised to secure blockchains, potentially to the extent where their immutability is such that 3rd party validation is no longer required.

Blockchain encryption is generally not contemplated (other than hashing) due to the key management problem. However, fractal keys can provide a solution to that problem and so encryption is a viable security option for blockchain endpoints as well as chain nodes.

Blockchain endpoints may be secured by obtaining an invisible key from the blockchain parent object for the first hash and then fractal encrypting the last chain hash every time the chain is expanded.

Blockchain nodes or links may be secured by encrypting the pre-hash data using the ID of the node, storing the crypt block for validation and recovery, and including the crypt block in the hash generation.

In all of these methods of blockchain security it is important to note that a master key, originating from an invisible fractal key, can propagate by way of a blockchain hierarchy and sequentially through the blockchain itself, being fractally morphed by each node using this invention, to be used as a key at each step.

While these methods definitely improve security and immutability, the fractal encryption process has the potential to deliver total data immutability for stand-alone databases.

The above encryption approach can secure both the start and end of a blockchain with a single fractal asset instance. This forms a blockchain loop that begins and ends in a fractal asset. Blockchain starting records generally only use the first record data to generate the first hash, which is fine as it is the last records hash that secures all the previous records.

This approach can provide localized blockchain loops that attach data to multiple fractal assets, and the ability to provide a fractal asset generated hash seed is very desirable as it guarantees that blockchain loop belongs to the fractal asset. The blockchain end hash is secured by encryption with a fractal key generated by the fractal asset, and/or a hierarchy of fractal assets.

The steps to implement such a process are as follows:
1) Configure fractal assets according to the teaching in PCT/AU2019/050928, the contents of which are incorporated herein by cross reference.
2) Configure a blockchain.
3) Obtain unique fractal key from the fractal asset [1]
4) Add data to the blockchain [2]
5) Concatenate the data and add unique fractal key [3] (first record) or the previous records hash (subsequent records) and use a hashing function to generate and store the current records hash from the concatenated data.
6) Obtain a second unique key from the fractal asset [1]
7) Encrypt a payload that includes the current (most recent) records hash [5]
8) Store the resulting crypt block as part of the fractal asset [1]
9) Repeat from [4] above to add more data

To validate the blockchain, re-process [5] for each record comparing the resulting hash to that in the blockchain. When the last record is reached, the second unique key [6] is obtained to decrypt the crypt block and compare the last hash to the encrypted payload. If they match the blockchain is valid, otherwise the blockchain is invalid. An invalid blockchain must be restored from a known valid backup.

There are several options to restore invalid blockchains:
1) Full database restore works if a full validation precedes each backup. This has the danger of losing records in unaffected blockchains in a multi-blockchain architecture.
2) Localised encrypted duplicates of blockchains using a third fractal asset [1] key.

This may be an encrypted XML extract of the database that is written after periodic blockchain validation or after every blockchain addition/update.

To configure the system a database schema is configured with 2 pairs of tables where each pair consists of:
1) A fractal asset table
2) A blockchain data table that has a relationship to the fractal asset table

The first pair contains definition data, where table [1] describes the purpose and table [2] describes the data to be stored in the blockchain. The second pair manifests instances of defined by the first table pair, where second pair contains the stored data. The second table pair are related to the first table pair. The first tables [1] of each pair have a hierarchical relationship to themselves to enable hierarchical structuring and ordering of objects.

### Quantum Proof Encryption

Additionally, it is theorized that fractal encryption becomes effectively impossible to crack by Quantum computers, that is, an instantaneous brute force attack, particularly if multiple encryption passes are processed according to the techniques described above.

The original data is encrypted using an unpredictable key the same size as the payload for each pass, where the key varies unpredictably with each pass. Furthermore, each pass dramatically ‘dilutes’ the payload contents, meaning that entirely new and unpredictable binary patterns are sequentially ‘pressed’ over the entire payload that essentially make it disappear. Consequently, the payload data simply no longer exists after only a few passes as it is virtually ‘overwritten’ by layers of unique unpredictable binary patterns, meaning patterns within the data cannot be used to assist with breaking the encryption.

Even given the ID and knowledge of the above process, if a key has been used to offset the start x,y the crypt block cannot be cracked without the key. This key can be based on a password, but may also be an ‘invisible fractal key’, as described above.

The Quantum capacity of brute forcing every possible key in near zero time requires that the Quantum logic knows what decrypted data looks like in order to determine which of all the keys was successful.

This current approach decrypts only with a specific fractal journey that involves the payload content and that content can only be recovered using that same journey, the start and end of that journey are within an infinitely complex fractal domain. Accordingly, unless the identifier, exact methodology and any keys are known, and correctly processed, the encryption is uncrackable by any method, including Quantum computing.

### EMBODIMENTS

A number of different example embodiments will now be described.

In a first embodiment a method of mapping unique IDs to unique fractal x,y locations is provided by survey of the fractal domain by a complexity function that excludes regions that contain infinite fractal values and to divide the ID binary sequences into 3 sections, where the maximum value of first matches the number of surveyed fractal regions, the second and third being x and y coordinates.

In a second embodiment, a method of mapping unique IDs according to the first embodiment is provided for every possible GUID.

In a third embodiment a method of fractal encryption is provided that encrypts data by geometric function sequences having their starting point mapped according to the first or second embodiments and where the payload is traversed in n bit steps and where a sequence of x,y fractal controlled geometric functions derive new x,y locations, each deriving fractal values from same locations, generating a unique fractal key of the same length as the payload that is merged with the payload by addition or subtraction of its n bit steps to create the crypt block.

In a fourth embodiment a method of fractal decryption is provided that repeats the steps in the third embodiment by inserting the crypt-block as the payload and reverses the addition or subtraction.

In a fifth embodiment a method of encryption and decryption according to third and fourth embodiments is provided where multiple passes transfer the crypt-block to the payload without resetting the last x,y fractal location.

In a sixth embodiment, a method of seeding a new x,y starting point using a key string that is processed according to the third embodiment is provided and does not load the buffer, prior to encryption of the payload according to the third embodiment, to generate a new x,y starting location.

In a seventh embodiment, a method of encryption and decryption according to the third and fourth embodiments is provided that is impossible to decrypt given only the crypt-block, even by Quantum Computers, by virtue of the unlimited size of the unpredictable key that is overlaid with multiple passes.

In an eighth embodiment, a method of generating invisible unpredictable keys from database IDs by encrypting strings of zero bits according to third embodiment is provided.

In a ninth embodiment method of seeding encryption according to the sixth embodiment using invisible keys according to the eighth embodiment is provided that create database encryption services for databases without key storage.

In a tenth embodiment a method of securing blockchain endpoints, the first and the last hash, by seeding the blockchain hash with an invisible key according to the eighth embodiment and storing the last hash encrypted according to the third embodiment using the ID of the blockchains parent object, is provided.

In an eleventh embodiment a method of securing each link or record in a blockchain by encrypting the secured content according to the third embodiment is provided using the record ID, storing the resulting crypt-block for data validation and restoration, and including the crypt-block in the hash generation.

Throughout this specification and claims which follow, unless the context requires otherwise, the word “comprise”, and variations such as “comprises” or “comprising”, will be understood to imply the inclusion of a stated integer or group of integers or steps but not the exclusion of any other integer or group of integers. As used herein and unless otherwise stated, the term “approximately” means±20%.

Persons skilled in the art will appreciate that numerous variations and modifications will become apparent. All such variations and modifications which become apparent to persons skilled in the art, should be considered to fall within the spirit and scope that the invention broadly appearing before described.

1: An encryption system, the system including one or more processing devices configured to encrypt data by determining a plurality of vectors within a defined complex number spatial region by using the complex number formula at one vector to determine the location of a next vector, beginning at a starting vector.

2: A system according to claim 1, wherein the one or more processing devices are configured to determine a plurality of encryption values by using the value derived using the complex number formula at a previous vector location to calculate a translation to a next vector location.

3-8. (canceled)

9: A system according to claim 1 or claim 2, wherein the one or more processing devices are configured to:
a) use the defined complex number formula to generate a fractal value for the vector location;
b) generate one or more translation values from the fractal value; and,
c) generate a geometric translation to determine a next vector location using the one or more translation values.

10: A system according to claim 9, wherein the one or more processing devices are configured to use translation values:
a) a first value representing a translation length; and,
b) a second value representing a translation angle.

11: A system according to claim 9, wherein the one or more processing devices are configured to:
a) determine an origin location within the spatial region using a starting vector; and,
b) determine subsequent vector locations using translations from at least one of:
i) previous vector location; and,
ii) the origin location.

12-13. (canceled)

14: A system according to claim 9, wherein the one or more processing devices are configured to encrypt a digital payload by:
a) segmenting the payload into a plurality of fragments; and,
b) iterating from the starting vector through subsequent vectors, the number of iterations ideally equaling the number of fragments; and,
c) calculating an encryption value at each vector using the defined complex number formula; and,
d) offsetting each fragment value in turn with the encryption values using a mathematical function to generate a cipher value; and optionally,
e) reordering the cipher using an order derived from the fractal values calculated.

15-21. (canceled)

22: A system according to claim 14, wherein the one or more processing devices are configured to decrypt a cipher generated by claim 14 by:
a) segment the cipher into a plurality of fragments similar to claim 14a; and,
b) iterating from the starting vector used at claim 14b through subsequent vectors, the number of iterations ideally equaling the number of fragments; and,
c) calculating an encryption value at each vector using the defined complex number formula; and,
d) offsetting each fragment value in turn with the encryption values using the reverse of the mathematical function applied at claim 14d to reveal the payload value; and optionally,
e) reordering the cipher using an order derived from the fractal values calculated.

23: A system according to claim 14, wherein the one or more processing devices are configured to further encrypt a digital payload by:
a) applying a number of passes described in claim 14 to the payload; and optionally,
b) reordering the cipher at each pass using an order derived from the fractal values calculated in each pass.

24: A system according to claim 22, wherein the one or more processing devices are configured to further decrypt a digital cipher by:
a) applying a number of reverse passes described in claim 22 to the cipher; and optionally,
b) reordering the cipher at each pass using an order derived from the fractal values calculated in each pass.

25: A system wherein the one or more processing devices are configured to generate a lookup table of optimized vector regions within a defined complex number spatial region by:
a) performing an x,y vector scan of the complex number spatial region; and,
b) measuring complexity at each x,y vector using the defined complex number formula; and
i) the complexity is measured by iteration depth; or,
ii) the complexity is measured by properties of the fractal value.

26: A system wherein the one or more processing devices are configured to convert a key of any size and content to an origin location and starting vector within the complex number space:
a) use a first portion of the key to determine a spatial x location; and,
b) use a second portion of the key to determine a spatial y location.

27: A system wherein the one or more processing devices are configured to convert a digital key of any size and content to an origin location and starting vector within the complex number space:
a) use the first portion of the key to determine the spatial region using a look-up table of complex number space vectors; and,
b) use a second portion of the key to determine a spatial x location, offset by the lookup table vector; and,
c) use a third portion of the key to determine a spatial y location, offset by the lookup table vector.

28: A system according to claim 14, wherein the one or more processing devices are configured to convert a digital key to a high quality cryptographic key:
a) the payload is a zero or other fixed value string, and;
b) claim 14 is used to encrypt the payload using any key, creating a cipher that is a high quality cryptographic key.

29: A system according to claim 9, wherein the one or more processing devices are configured to encrypt database data by:
a) the payload is assembled from a records data; and,
b) the key is the records unique identifier or GUID id; and optionally,
c) the record unique identifier is combined with one or more keys.

30: A system according to claim 14 or claim 27, wherein the one or more processing devices are configured to secure a blockchain by:
a) the blockchain ending hash is encrypted according to claim 14; and,
b) the cipher is stored with the hash; and optionally,
c) the blockchain starting hash is a high quality cryptographic key generated according to claim 27; and optionally,
d) the whole blockchain contents are encrypted according to claim 14.
